(19) United States
(12) Patent Application Publication
(10) Pub. No.: US 2021/0101620 A1
(43) Pub. Date: Apr. 8, 2021

(54) SYSTEMS, METHODS, AND DEVICES FOR GENERATING AND USING SAFETY THREAT MAPS

(71) Applicant: Intel Corporation, Santa Clara, CA (US)

(72) Inventors: Cornelius BUERKLE, Karlsruhe (DE); Fabian OBORIL, Karlsruhe (DE); Ignacio ALVAREZ, Portland, OR (US); Maria Soledad ELLI, Hillsboro, OR (US); David Israel GONZÁLEZ AGUIRRE, Hillsboro, OR (US)

(21) Appl. No.: 17/124,531

(22) Filed: Dec. 17, 2020

(51) Int. Cl. B60W 60/00; G08G 1/16; G05D 1/02; G01C 21/00; B60W 30/095; B60W 30/09; B60W 10/18; B60W 10/20; B60W 50/06; B60W 30/18

(52) U.S. Cl. CPC B60W 60/0015; B60W 2520/06; G08G 1/166; G05D 1/0214; G05D 1/0223; G01C 21/3833; B60W 30/0956; B60W 30/09; B60W 10/18; B60W 10/20; B60W 50/06; B60W 30/0953; B60W 30/18163; G05D 2201/0213; B60W 2554/4042; B60W 2554/4043; B60W 2554/80; G08G 1/167

(57) ABSTRACT

A method for creating a road user spatio-temporal representation or threat map includes obtaining electronic map data for a spatial region and a plurality of map layers. Creating a map layer includes setting parameter(s) for a vehicle with respect to the map layer. For each subsection of the spatial region, creating the map layer includes defining a position and heading for the vehicle for each of the respective subsections and representing at least one object in the respective subsection using one or more probabilistic distributions with respect to at least velocity and position of the at least one object, and determining a collision risk value between the ego vehicle and the at least one object. The threat map is generated from the map layers with maximum acceptable collision risk values from the map layers.

### TECHNICAL FIELD

Various aspects of this disclosure generally relate to generation and use of threat maps.

### BACKGROUND

For development the massive deployment of vehicles such as autonomous vehicles (AVs) or advanced driving assistance vehicles, providing safety assurance is critical. In particular, safety under the presence of uncertainties and errors in the sensing and perception components needs to be assured. For example, a driving safety model can include formal definitions of safety constraints that establish when the interactions between an ego vehicle and other traffic participants are dangerous. However, driving safety models typically require multiple real-time safety computations per ego-road agent pair. An increase in the number of vehicles requires an increase in computational resources for driving safety model in order to maintain run-time capabilities. Hence, evaluating safety constraints in the environment imposes a big overhead during decision-making runtime because driving safety model computations required to enable the driving safety model checks are very computationally expensive.

A sophisticated situation analysis is required to understand the exact constellation of the vehicles (e.g. following case, vs. approaching case, vs. intersection case, etc.), and, for each analysis, a new lane coordinate system can be constructed, thus making a conversion from the Cartesian space to this new coordinate system necessary. As a result, performing driving safety model checks can quickly become a limiting factor, especially considering that these computations must be calculated on a safety certified computing device. Further, perception uncertainties and errors, such as false negatives, have a direct impact on the safety of the vehicle. Similarly, objects that are not inside the reachable critical region may be treated differently during trajectory planning.

### BRIEF DESCRIPTION OF THE DRAWINGS

In the drawings, like reference characters generally refer to the same parts throughout the different views. The drawings are not necessarily to scale; emphasis instead generally being placed upon illustrating the principles of the invention. In the following description, various aspects of the invention are described with reference to the following drawings, in which:

FIG. 1 shows an exemplary autonomous vehicle in accordance with various aspects of the present disclosure.

FIG. 2 shows various exemplary electronic components of a safety system of the vehicle in accordance with various aspects of the present disclosure.

FIG. 3 shows an exemplary representation of a process flow for generating a threat map according to aspects of the present disclosure.

FIG. 4 shows an exemplary representation of a threat map with unsafe longitudinal velocity values for an ego vehicle according to aspects of the present disclosure.

FIG. 5 shows an exemplary example representation of a multi-layer threat map with unsafe longitudinal velocity values for an ego vehicle traveling at difference velocities according to aspects of the present disclosure.

FIG. 6 shows an exemplary example representation of a threat map with unsafe lateral velocity values for an ego vehicle according to aspects of the present disclosure.

FIG. 7 shows an exemplary graph representing longitudinal critical values for a traffic situation according to aspects of the present disclosure.

FIG. 8 shows an exemplary representation of a plurality of different traffic situations.

FIG. 9 shows an exemplary process for using a threat map according to aspects of the present disclosure.

FIG. 10 shows an exemplary process for generating a threat map according to aspects of the present disclosure.

FIG. 11 shows an exemplary process for utilizing a threat map according to aspects of the present disclosure.

### DESCRIPTION

The following detailed description refers to the accompanying drawings that show, by way of illustration, exemplary details and aspects in which the invention may be practiced.

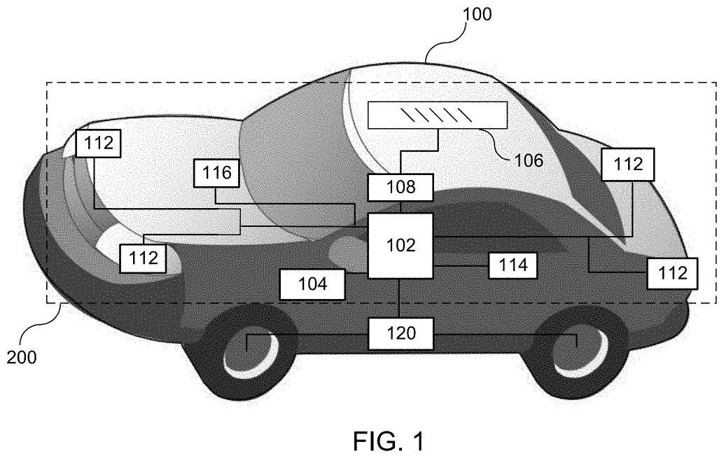

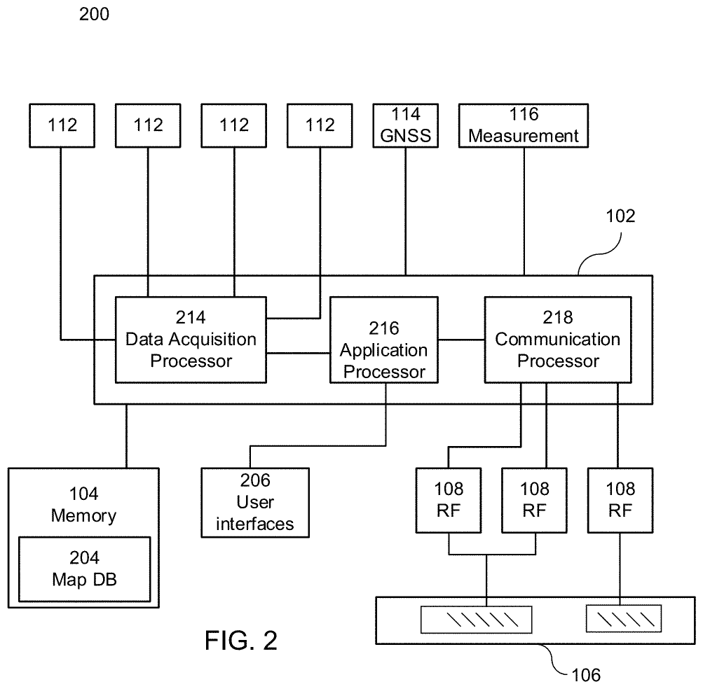

FIG. 1 shows a vehicle 100 including a mobility system 120 and a control system 200 (see also FIG. 2) in accordance with various aspects. It is appreciated that vehicle 100 and control system 200 are exemplary in nature and may thus be simplified for explanatory purposes. For example, while vehicle 100 is depicted as a ground vehicle, aspects of this disclosure may be equally or analogously applied to aerial vehicles such as drones or aquatic vehicles such as boats. Furthermore, the quantities and locations of elements, as well as relational distances (as discussed above, the figures are not to scale) are provided as examples and are not limited thereto. The components of vehicle 100 may be arranged around a vehicular housing of vehicle 100, mounted on or outside of the vehicular housing, enclosed within the vehicular housing, or any other arrangement relative to the vehicular housing where the components move with vehicle 100 as it travels. The vehicular housing, such as an automobile body, drone body, plane or helicopter fuselage, boat hull, or similar type of vehicular body dependent on the type of vehicle that vehicle 100 is.

In addition to including a control system 200, vehicle 100 may also include a mobility system 120. Mobility system 120 may include components of vehicle 100 related to steering and movement of vehicle 100. In some aspects, where vehicle 100 is an automobile, for example, mobility system 120 may include wheels and axles, a suspension, an engine, a transmission, brakes, a steering wheel, associated electrical circuitry and wiring, and any other components used in the driving of an automobile. In some aspects, where vehicle 100 is an aerial vehicle, mobility system 120 may include one or more of rotors, propellers, jet engines, wings, rudders or wing flaps, air brakes, a yoke or cyclic, associated electrical circuitry and wiring, and any other components used in the flying of an aerial vehicle. In some aspects, where vehicle 100 is an aquatic or sub-aquatic vehicle, mobility system 120 may include any one or more of rudders, engines, propellers, a steering wheel, associated electrical circuitry and wiring, and any other components used in the steering or movement of an aquatic vehicle. In some aspects, mobility system 120 may also include autonomous driving functionality, and accordingly may include an interface with one or more processors 102 configured to perform autonomous driving computations and decisions and an array of sensors for movement and obstacle sensing. In this sense, the mobility system 120 may be provided with instructions to direct the navigation and/or mobility of vehicle 100 from one or more components of the control system 200. The autonomous driving components of mobility system 120 may also interface with one or more radio frequency (RF) transceivers 108 to facilitate mobility coordination with other nearby vehicular communication devices and/or central networking components that perform decisions and/or computations related to autonomous driving.

The control system 200 may include various components depending on the requirements of a particular implementation. As shown in FIG. 1 and FIG. 2, the control system 200 may include one or more processors 102, one or more memories 104, an antenna system 106 which may include one or more antenna arrays at different locations on the vehicle for radio frequency (RF) coverage, one or more radio frequency (RF) transceivers 108, one or more data acquisition devices 112, one or more position devices 114 which may include components and circuitry for receiving and determining a position based on a Global Navigation Satellite System (GNSS) and/or a Global Positioning System (GPS), and one or more measurement sensors 116, e.g. speedometer, altimeter, gyroscope, velocity sensors, etc.

The control system 200 may be configured to control the vehicle's 100 mobility via mobility system 120 and/or interactions with its environment, e.g. communications with other devices or network infrastructure elements (NIEs) such as base stations, via data acquisition devices 112 and the radio frequency communication arrangement including the one or more RF transceivers 108 and antenna system 106.

The one or more processors 102 may include a data acquisition processor 214, an application processor 216, a communication processor 218, and/or any other suitable processing device. Each processor 214, 216, 218 of the one or more processors 102 may include various types of hardware-based processing devices. By way of example, each processor 214, 216, 218 may include a microprocessor, pre-processors (such as an image pre-processor), graphics processors, a central processing unit (CPU), support circuits, digital signal processors, integrated circuits, memory, or any other types of devices suitable for running applications and for image processing and analysis. In some aspects, each processor 214, 216, 218 may include any type of single or multi-core processor, mobile device microcontroller, central processing unit, etc. These processor types may each include multiple processing units with local memory and instruction sets. Such processors may include video inputs for receiving image data from multiple image sensors and may also include video out capabilities.

Any of the processors 214, 216, 218 disclosed herein may be configured to perform certain functions in accordance with program instructions which may be stored in a memory of the one or more memories 104. In other words, a memory of the one or more memories 104 may store software that, when executed by a processor (e.g., by the one or more processors 102), controls the operation of the system, e.g., a driving and/or safety system. A memory of the one or more memories 104 may store one or more databases and image processing software, as well as a trained system, such as a neural network, or a deep neural network, for example. The one or more memories 104 may include any number of random-access memories, read only memories, flash memories, disk drives, optical storage, tape storage, removable storage and other types of storage. Alternatively, each of processors 214, 216, 218 may include an internal memory for such storage.

The data acquisition processor 216 may include processing circuitry, such as a CPU, for processing data acquired by data acquisition units 112. For example, if one or more data acquisition units are image acquisition units, e.g. one or more cameras, then the data acquisition processor may include image processors for processing image data using the information obtained from the image acquisition units as an input. The data acquisition processor 216 may therefore be configured to create voxel maps detailing the surrounding of the vehicle 100 based on the data input from the data acquisition units 112, i.e., cameras in this example.

Application processor 216 may be a CPU, and may be configured to handle the layers above the protocol stack, including the transport and application layers. Application processor 216 may be configured to execute various applications and/or programs of vehicle 100 at an application layer of vehicle 100, such as an operating system (OS), a user interfaces (UI) 206 for supporting user interaction with vehicle 100, and/or various user applications. Application processor 216 may interface with communication processor 218 and act as a source (in the transmit path) and a sink (in the receive path) for user data, such as voice data, audio/video/image data, messaging data, application data, basic Internet/web access data, etc. In the transmit path, communication processor 218 may therefore receive and process outgoing data provided by application processor 216 according to the layer-specific functions of the protocol stack, and provide the resulting data to digital signal processor 208. Communication processor 218 may then perform physical layer processing on the received data to produce digital baseband samples, which digital signal processor may provide to RF transceiver(s) 108. RF transceiver(s) 108 may then process the digital baseband samples to convert the digital baseband samples to analog RF signals, which RF transceiver(s) 108 may wirelessly transmit via antenna system 106. In the receive path, RF transceiver(s) 108 may receive analog RF signals from antenna system 106 and process the analog RF signals to obtain digital baseband samples. RF transceiver(s) 108 may provide the digital baseband samples to communication processor 218, which may perform physical layer processing on the digital baseband samples. Communication processor 218 may then provide the resulting data to other processors of the one or more processors 102, which may process the resulting data according to the layer-specific functions of the protocol stack and provide the resulting incoming data to application processor 216. Application processor 216 may then handle the incoming data at the application layer, which can include execution of one or more application programs with the data and/or presentation of the data to a user via one or more user interfaces 206. User interfaces 206 may include one or more screens, microphones, mice, touchpads, keyboards, or any other interface providing a mechanism for user input.

The communication processor 218 may include a digital signal processor and/or a controller which may direct such communication functionality of vehicle 100 according to the communication protocols associated with one or more radio access networks, and may execute control over antenna system 106 and RF transceiver(s) 108 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness, the configuration of vehicle 100 shown in FIGS. 1 and 2 may depict only a single instance of such components.

Vehicle 100 may transmit and receive wireless signals with antenna system 106, which may be a single antenna or an antenna array that includes multiple antenna elements. In some aspects, antenna system 202 may additionally include analog antenna combination and/or beamforming circuitry. In the receive (RX) path, RF transceiver(s) 108 may receive analog radio frequency signals from antenna system 106 and perform analog and digital RF front-end processing on the analog radio frequency signals to produce digital baseband samples (e.g., In-Phase/Quadrature (IQ) samples) to provide to communication processor 218. RF transceiver(s) 108 may include analog and digital reception components including amplifiers (e.g., Low Noise Amplifiers (LNAs)), filters, RF demodulators (e.g., RF IQ demodulators)), and analog-to-digital converters (ADCs), which RF transceiver(s) 108 may utilize to convert the received radio frequency signals to digital baseband samples. In the transmit (TX) path, RF transceiver(s) 108 may receive digital baseband samples from communication processor 218 and perform analog and digital RF front-end processing on the digital baseband samples to produce analog radio frequency signals to provide to antenna system 106 for wireless transmission. RF transceiver(s) 108 may thus include analog and digital transmission components including amplifiers (e.g., Power Amplifiers (PAs), filters, RF modulators (e.g., RF IQ modulators), and digital-to-analog converters (DACs), which RF transceiver(s) 108 may utilize to mix the digital baseband samples received from communication processor 218 and produce the analog radio frequency signals for wireless transmission by antenna system 106. In some aspects, communication processor 218 may control the radio transmission and reception of RF transceiver(s) 108, including specifying the transmit and receive radio frequencies for operation of RF transceiver(s) 108.

According to some aspects, communication processor 218 includes a baseband modem configured to perform physical layer (PHY, Layer 1) transmission and reception processing to, in the transmit path, prepare outgoing transmit data provided by communication processor 218 for transmission via RF transceiver(s) 108, and, in the receive path, prepare incoming received data provided by RF transceiver(s) 108 for processing by communication processor 218. The baseband modem may include a digital signal processor and/or a controller. The digital signal processor may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. The digital signal processor may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, the digital signal processor may include one or more processors configured to retrieve and execute program code that defines control and processing logic for physical layer processing operations. In some aspects, the digital signal processor may execute processing functions with software via the execution of executable instructions. In some aspects, the digital signal processor may include one or more dedicated hardware circuits (e.g., ASICs, FPGAs, co-processors, and other hardware) that are digitally configured to execute specific processing functions, where the one or more processors of digital signal processor may offload certain processing tasks to these dedicated hardware circuits, which are known as hardware accelerators. Exemplary hardware accelerators can include Fast Fourier Transform (FFT) circuits and encoder/decoder circuits. In some aspects, the processor and hardware accelerator components of the digital signal processor may be realized as a coupled integrated circuit.

Vehicle 100 may be configured to operate according to one or more radio communication technologies. The digital signal processor of the communication processor 218 may be responsible for lower-layer processing functions (e.g., Layer 1/PHY) of the radio communication technologies, while a controller of the communication processor 218 may be responsible for upper-layer protocol stack functions (e.g., Data Link Layer/Layer 2 and/or Network Layer/Layer 3). The controller may thus be responsible for controlling the radio communication components of vehicle 100 (antenna system 106, RF transceiver(s) 108, position device 114, etc.) in accordance with the communication protocols of each supported radio communication technology, and accordingly may represent the Access Stratum and Non-Access Stratum (NAS) (also encompassing Layer 2 and Layer 3) of each supported radio communication technology. The controller may be structurally embodied as a protocol processor configured to execute protocol stack software (retrieved from a controller memory) and subsequently control the radio communication components of vehicle 100 to transmit and receive communication signals in accordance with the corresponding protocol stack control logic defined in the protocol stack software. The controller may include one or more processors configured to retrieve and execute program code that defines the upper-layer protocol stack logic for one or more radio communication technologies, which can include Data Link Layer/Layer 2 and Network Layer/Layer 3 functions. The controller may be configured to perform both user-plane and control-plane functions to facilitate the transfer of application layer data to and from vehicle 100 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by the controller of communication processor 218 may include executable instructions that define the logic of such functions.

In some aspects, vehicle 100 may be configured to transmit and receive data according to multiple radio communication technologies. Accordingly, in some aspects one or more of antenna system 106, RF transceiver(s) 108, and communication processor 218 may include separate components or instances dedicated to different radio communication technologies and/or unified components that are shared between different radio communication technologies. For example, in some aspects, multiple controllers of communication processor 218 may be configured to execute multiple protocol stacks, each dedicated to a different radio communication technology and either at the same processor or different processors. In some aspects, multiple digital signal processors of communication processor 218 may include separate processors and/or hardware accelerators that are dedicated to different respective radio communication technologies, and/or one or more processors and/or hardware accelerators that are shared between multiple radio communication technologies. In some aspects, RF transceiver(s) 108 may include separate RF circuitry sections dedicated to different respective radio communication technologies, and/or RF circuitry sections shared between multiple radio communication technologies. In some aspects, antenna system 106 may include separate antennas dedicated to different respective radio communication technologies, and/or antennas shared between multiple radio communication technologies. Accordingly, antenna system 106, RF transceiver(s) 108, and communication processor 218 can encompass separate and/or shared components dedicated to multiple radio communication technologies.

Communication processor 218 may be configured to implement one or more vehicle-to-everything (V2X) communication protocols, which may include vehicle-to-vehicle (V2V), vehicle-to-infrastructure (V2I), vehicle-to-network (V2N), vehicle-to-pedestrian (V2P), vehicle-to-device (V2D), vehicle-to-grid (V2G), and other protocols. Communication processor 218 may be configured to transmit communications including communications (one-way or two-way) between the vehicle 100 and one or more other (target) vehicles in an environment of the vehicle 100 (e.g., to facilitate coordination of navigation of the vehicle 100 in view of or together with other (target) vehicles in the environment of the vehicle 100), or even a broadcast transmission to unspecified recipients in a vicinity of the transmitting vehicle 100.

Communication processor 218 may be configured to operate via a first RF transceiver of the one or more RF transceivers(s) 108 according to different desired radio communication protocols or standards. By way of example, communication processor 218 may be configured in accordance with a Short-Range mobile radio communication standard such as e.g. Bluetooth, Zigbee, and the like, and the first RF transceiver may correspond to the corresponding Short-Range mobile radio communication standard. As another example, communication processor 218 may be configured to operate via a second RF transceiver of the one or more RF transceivers(s) 108 in accordance with a Medium or Wide Range mobile radio communication standard such as, e.g., a 3G (e.g. Universal Mobile Telecommunications System—UMTS), a 4G (e.g. Long Term Evolution—LTE), or a 5G mobile radio communication standard in accordance with corresponding 3GPP (3^{rd} Generation Partnership Project) standards. As a further example, communication processor 218 may be configured to operate via a third RF transceiver of the one or more RF transceivers(s) 108 in accordance with a Wireless Local Area Network communication protocol or standard such as e.g. in accordance with IEEE 802.11 (e.g. 802.11, 802.11a, 802.11b, 802.11g, 802.11n, 802.11p, 802.11-12, 802.11ac, 802.11ad, 802.11ah, and the like). The one or more RF transceiver(s) 108 may be configured to transmit signals via antenna system 106 over an air interface. The RF transceivers 108 may each have a corresponding antenna element of antenna system 106, or may share an antenna element of the antenna system 106.

Memory 214 may embody a memory component of vehicle 100, such as a hard drive or another such permanent memory device. Although not explicitly depicted in FIGS. 1 and 2, the various other components of vehicle 100, e.g. one or more processors 102, shown in FIGS. 1 and 2 may additionally each include integrated permanent and non-permanent memory components, such as for storing software program code, buffering data, etc.

The antenna system 106 may include a single antenna or multiple antennas. In some aspects, each of the one or more antennas of antenna system 106 may be placed at a plurality of locations on the vehicle 100 in order to ensure maximum RF coverage. The antennas may include a phased antenna array, a switch-beam antenna array with multiple antenna elements, etc. Antenna system 106 may be configured to operate according to analog and/or digital beamforming schemes in order to maximize signal gains and/or provide levels of information privacy. Antenna system 106 may include separate antennas dedicated to different respective radio communication technologies, and/or antennas shared between multiple radio communication technologies. While shown as a single element in FIG. 1, antenna system 106 may include a plurality of antenna elements (e.g., antenna arrays) positioned at different locations on vehicle 100. The placement of the plurality of antenna elements may be strategically chosen in order to ensure a desired degree of RF coverage. For example, additional antennas may be placed at the front, back, corner(s), and/or on the side(s) of the vehicle 100.

Data acquisition devices 112 may include any number of data acquisition devices and components depending on the requirements of a particular application. This may include: image acquisition devices, proximity detectors, acoustic sensors, infrared sensors, piezoelectric sensors, etc., for providing data about the vehicle's environment. Image acquisition devices may include cameras (e.g., standard cameras, digital cameras, video cameras, single-lens reflex cameras, infrared cameras, stereo cameras, etc.), charge coupling devices (CCDs) or any type of image sensor. Proximity detectors may include radar sensors, light detection and ranging (LIDAR) sensors, mmWave radar sensors, etc. Acoustic sensors may include: microphones, sonar sensors, ultrasonic sensors, etc. Accordingly, each of the data acquisition units may be configured to observe a particular type of data of the vehicle's 100 environment and forward the data to the data acquisition processor 214 in order to provide the vehicle with an accurate portrayal of the vehicle's environment. The data acquisition devices 112 may be configured to implement pre-processed sensor data, such as radar target lists or LIDAR target lists, in conjunction with acquired data.

Measurement devices 116 may include other devices for measuring vehicle-state parameters, such as a velocity sensor (e.g., a speedometer) for measuring a velocity of the vehicle 100, one or more accelerometers (either single axis or multi-axis) for measuring accelerations of the vehicle 100 along one or more axes, a gyroscope for measuring orientation and/or angular velocity, odometers, altimeters, thermometers, etc. It is appreciated that vehicle 100 may have different measurement devices 116 depending on the type of vehicle it is, e.g., car vs. drone vs. boat.

Position devices 114 may include components for determining a position of the vehicle 100. For example, this may include global position system (GPS) or other global navigation satellite system (GNSS) circuitry configured to receive signals from a satellite system and determine a position of the vehicle 100. Position devices 114, accordingly, may provide vehicle 100 with satellite navigation features.

The one or more memories 104 may store data, e.g., in a database or in any different format, that may correspond to a map. For example, the map may indicate a location of known landmarks, roads, paths, network infrastructure elements, or other elements of the vehicle's 100 environment. The one or more processors 102 may process sensory information (such as images, radar signals, depth information from LIDAR, or stereo processing of two or more images) of the environment of the vehicle 100 together with position information, such as a GPS coordinate, a vehicle's ego-motion, etc., to determine a current location of the vehicle 100 relative to the known landmarks, and refine the determination of the vehicle's location. Certain aspects of this technology may be included in a localization technology such as a mapping and routing model.

The map database (DB) 204 may include any type of database storing (digital) map data for the vehicle 100, e.g., for the control system 200. The map database 204 may include data relating to the position, in a reference coordinate system, of various items, including roads, water features, geographic features, businesses, points of interest, restaurants, gas stations, etc. The map database 204 may store not only the locations of such items, but also descriptors relating to those items, including, for example, names associated with any of the stored features. In some aspects, a processor of the one or more processors 102 may download information from the map database 204 over a wired or wireless data connection to a communication network (e.g., over a cellular network and/or the Internet, etc.). In some cases, the map database 204 may store a sparse data model including polynomial representations of certain road features (e.g., lane markings) or target trajectories for the vehicle 100. The map database 204 may also include stored representations of various recognized landmarks that may be provided to determine or update a known position of the vehicle 100 with respect to a target trajectory. The landmark representations may include data fields such as landmark type, landmark location, among other potential identifiers.

Furthermore, the control system 200 may include a driving model, e.g., implemented in an advanced driving assistance system (ADAS) and/or a driving assistance and automated driving system. By way of example, the control system 200 may include (e.g., as part of the driving model) a computer implementation of a formal model such as a safety driving model. A safety driving model may be or include a mathematical model formalizing an interpretation of applicable laws, standards, policies, etc. that are applicable to self-driving vehicles. A safety driving model may be designed to achieve, e.g., three goals: first, the interpretation of the law should be sound in the sense that it complies with how humans interpret the law; second, the interpretation should lead to a useful driving policy, meaning it will lead to an agile driving policy rather than an overly-defensive driving which inevitably would confuse other human drivers and will block traffic and in turn limit the scalability of system deployment; and third, the interpretation should be efficiently verifiable in the sense that it can be rigorously proven that the self-driving (autonomous) vehicle correctly implements the interpretation of the law. A safety driving model, illustratively, may be or include a mathematical model for safety assurance that enables identification and performance of proper responses to dangerous situations such that self-perpetrated accidents can be avoided.

As described above, the vehicle 100 may include the control system 200 as also described with reference to FIG. 2. The vehicle 100 may include the one or more processors 102 integrated with or separate from an engine control unit (ECU) which may be included in the mobility system 120 of the vehicle 100. The control system 200 may, in general, generate data to control or assist to control the ECU and/or other components of the vehicle 100 to directly or indirectly control the movement of the vehicle 100 via mobility system 120. The one or more processors 102 of the vehicle 100 may be configured to implement the aspects and methods described herein, including performing various calculations, determinations, etc.

The components illustrated in FIGS. 1 and 2 may be operatively connected to one another via any appropriate interfaces. Furthermore, it is appreciated that not all the connections between the components are explicitly shown, and other interfaces between components may be covered within the scope of this disclosure.

Various examples herein relate to generation of threat maps and describes methods for threat map calculation and representation. The threat maps described herein may be considered as a road user safety spatio-temporal representation and can deal with issues concerning attention and anticipation mechanisms in connection with vehicles (e.g., AVs) embodiments. This threat map can include a data structure(s) that define safety-relevant regions around a vehicle (e.g., AV) using probabilistic constraints. A dangerous situation between two traffic participants is always a combination of a delta in distance and delta in velocity. Given the velocity of the ego vehicle and a formal safety driving model, it is possible to determine for each spatial region around the ego vehicle the minimal velocity of the other road user that would impose a safety threat to the vehicle.

The threat map can be determined or computed and stored offline. In a dynamic programming approach, information about the regions around an ego vehicle or AV that are safety relevant are stored, taking into account the ego vehicle's parameters (e.g., velocity) as well as reasonable and foreseeable potential velocities and headings of road-agents in the surroundings of the AV. Additionally, a probabilistic computation of the risk-distribution based on the vehicle's certainty of its sensing capabilities is available at each discrete spatial location also called map-cell. Using this risk-aware spatial threat map will allow the ego vehicle or AV to evaluate (online) the safety of the current state of the system with respect to each surrounding road user more efficiently and accurately, allowing the ego vehicle to take preventive actions when safety being jeopardized.

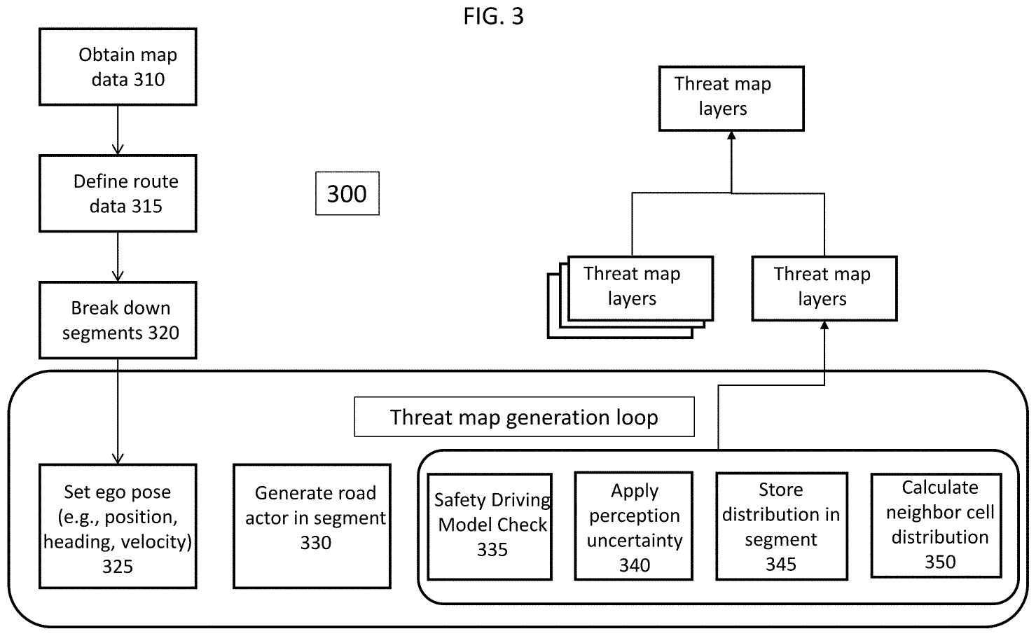

FIG. 3 shows an exemplary representation of a process flow 300 for generating a threat map according to aspects of the present disclosure. The process flow may be carried out or executed by a computing system that includes at least one processor along with any other suitable or necessary computing components, including for example, memory, storage, etc.

The process 300 may include obtaining 310 an electronic map or electronic map data. The electronic map data may include be for one more spatial regions. The spatial regions may correspond to various geographical areas related to known vehicular routes or paths. After obtaining the electronic map data, route data may be defined for the map data at 315 (if it has not already been defined). That is, navigable routes or paths for a vehicle can travel may be defined or included in the map data.

Further, at 320 the electronic data map may be broken down or defined into smaller segments or subsections. This segmentation can allow for easier processing and generation of the threat map by considering the map in smaller pieces. Segmentation may not be necessary to the extent the map data is not already sufficiently segmented.

After segmentation, the threat generation process can include selecting a subsection or segment of the electronic map for processing. At 325, for the selected map segment, the process includes defining or setting a pose for an ego vehicle. That is, parameters or physical characteristics for the ego vehicle. The parameters may be set with respect to the segment and can include for example, position, heading, etc.

Further, at 330, at least one road actor or object may be generated or defined. Road actor, users, or objects may include other vehicles, pedestrians, bicyclists, animals, or any other possible element that may be a factor or influence a traffic situation. The road actor or object, like the ego vehicle, can be defined or characterized and have for example, e.g., a position, velocity, heading, etc. in the selected map segment.

In FIG. 3, for the threat generation loop, after defining an ego-road actor pair for as segment, then at 335, a safety driving model can be used to determine values for parameters (e.g., velocity of road object) or for the at least one object that would impose a safety threat to the ego vehicle traveling at the set velocity at the defined position and heading by considering one or more traffic situations between the ego vehicle and the at least one road object. In other words, the safety driving model can be used to determine the parameters (e.g., velocity) which lead to states where the ego vehicle is unsafe. For example, a safety driving model can be used to apply the ego vehicle's position and velocity (for a current map layer) and check against surrounding traffic participants' or the generated road actor(s)' position and velocity.

To perform the safety checks, a safety driving system using a safety driving model may use a minimum safety distance metric based on the distance between the ego vehicle and road object and the velocities in both lateral and longitudinal direction for the ego vehicle and road object. If determined lateral and longitudinal distances between the ego-road object pair is less than the ones indicated by a safety driving model, then the situation is defined as unsafe. For example, the safe longitudinal distance between to vehicles driving in same direction can be described in following equation:

$${d}_{min}^{long} = {[ {v}_{f} ρ + \frac{1}{2} {a}_{max , accel} {ρ}^{2} + \frac{{( {v}_{f} + ρ {a}_{max , accel} )}^{2}}{2 {a}_{min , brake}} - \frac{{( {v}_{l} )}^{2}}{2 {a}_{max , brake}} ]}_{+} \qquad ( 1 )$$

where
vᵣ=longitudinal speed of the rear car [m/s],
v_{f}=longitudinal speed of the front car [m/s],
a_{max,accel}=maximum possible longitudinal acceleration of the rear car during response time [m/s\hat{ }2],
a_{min,brake}=minimum longitudinal braking of the rear car [m/s\hat{ }2],
a_{max,brake}=maximum assumed longitudinal braking of the front car [m/s\hat{ }2], and
ρ=the response time.

The parameters a_{min,brake} and a_{max,brake} are fixed parameters and v_{f} and vₗ are the ego vehicle and front object/vehicle respectively. The parameter p can be a constant that can be defined in a reasonable manner (e.g., freely selectable). Therefore, for a given vehicle velocity v_{f}, a safe distance can depend only on vₗ. Therefore, it is possible to calculate, for any distance d in front of the ego vehicle, the velocity vₗ that would lead to an unsafe situation (where d<dₘᵢₙ^{long}) This can be called an unsafe velocity. This velocity-distance relation is independent from the dynamic parts of the environment and therefore can be calculated upfront for each value of ego vehicle velocity.

According to one aspect of the present disclosure, threat map layers and threat maps can be generated based on determined unsafe velocities. For a threat map layer, each subsection or segment thereof can include or indicate an unsafe velocity (e.g., with longitudinal and lateral components) or the velocity in which an object is considered a potential safety threat, as defined by a safety driving model. This velocity may be a velocity that is determined to be unsafe for one or more traffic situations.

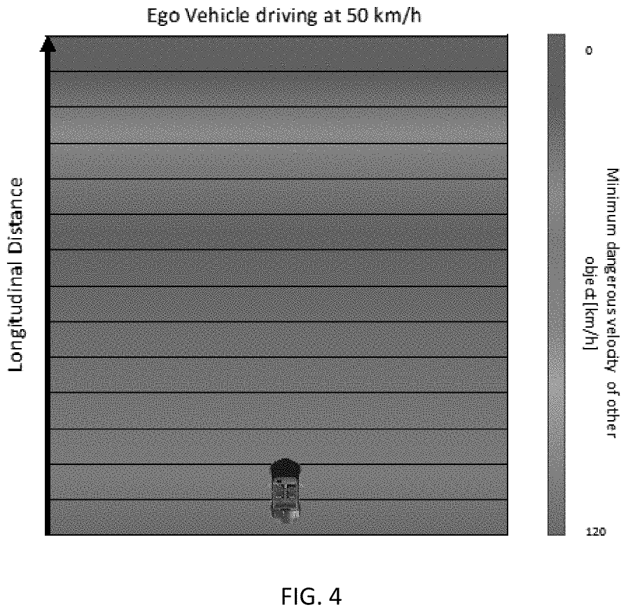

FIG. 4 shows an exemplary representation of a threat map with unsafe longitudinal velocity values for an ego vehicle driving at 50 km/h and considering only longitudinal conflicts with a road object or vehicle that is driving in the same direction as defined by equation (1). As expected, as the longitudinal distance decreases between the object located in front (indicated by upward arrow direction), the minimum dangerous velocity decreases.

Since an ego vehicle can travel with various velocities, it may not be useful to only have a threat map being a single layer grid of unsafe velocities corresponding to a single ego vehicle velocity. Instead, a multi-layer representation can be used. In such an approach a plurality of threat map layers is generated with each layer having unsafe velocities corresponding or based on to a different sampled ego velocity (e.g. 50, 100, 120 km/h, etc.). In various cases, the amount of map layers and choice of parameter (e.g., velocity) can vary.

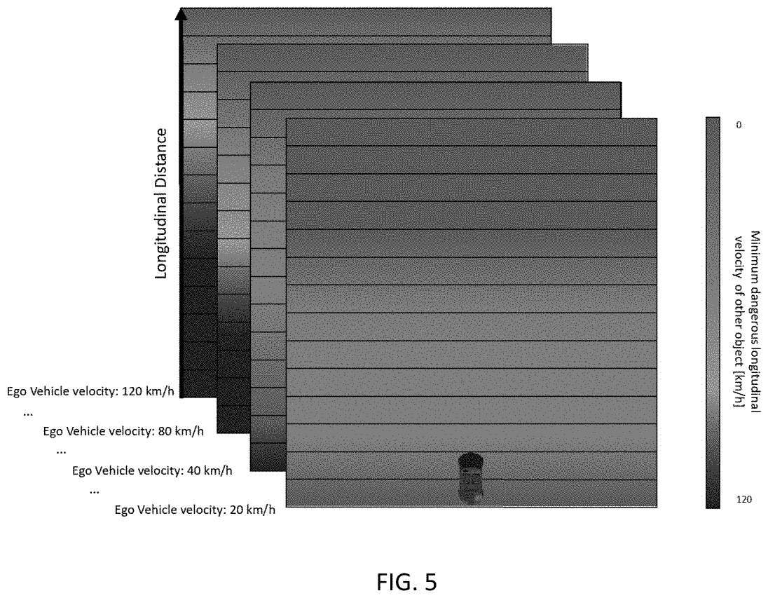

An example showing a representation of multiple threat map layers for longitudinal distances can be shown in FIG. 5. More specifically, FIG. 5 shows unsafe longitudinal velocity values at different distances per each ego vehicle velocity (120 km/h, 80 km/h, etc.) which can be calculated based on equation (1).

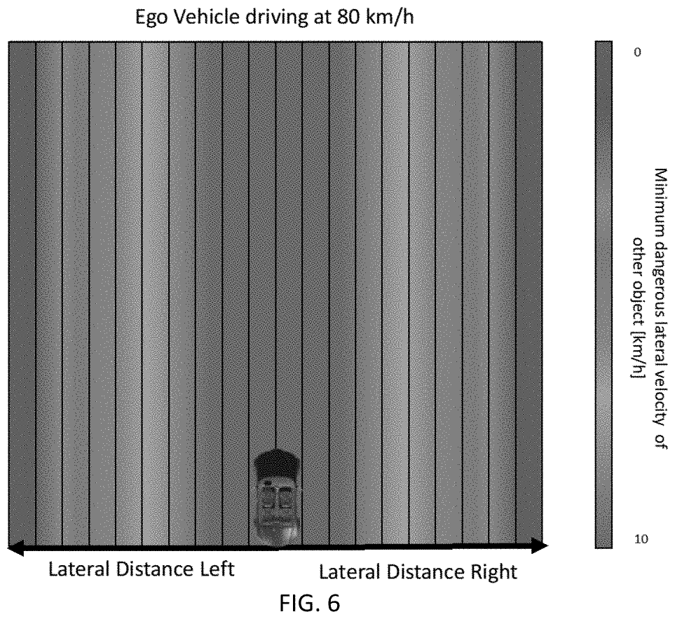

For example, for the lateral velocities, one can calculate the unsafe velocities based on the lateral distance right and left. An example for the ego vehicle driving at 80 km/h is shown in FIG. 6 with the corresponding minimum velocities only according to lateral distances. Like with longitudinal distances, the minimum unsafe lateral velocities using a multi-layer approach may be implemented.

Further, a threat map may also incorporate lateral conflicts with one or several road objects or actors (e.g., vehicles, bicyclists, pedestrians, stationary objects, etc.).

Accordingly, both lateral and longitudinal unsafe distances calculated at each possible ego vehicle velocity can be used or combined for a unified map representation. Specifically, the unsafe velocities from each of multiple threat map layers 370 may be used to produce a final single threat map. This final threat map produced can include a minimum unsafe velocity for each subsection or cell. For each segment of the threat map, the specified minimum unsafe velocity can be the minimum unsafe velocity of the set of unsafe velocities from the corresponding or same segments of the individual threat map layers.

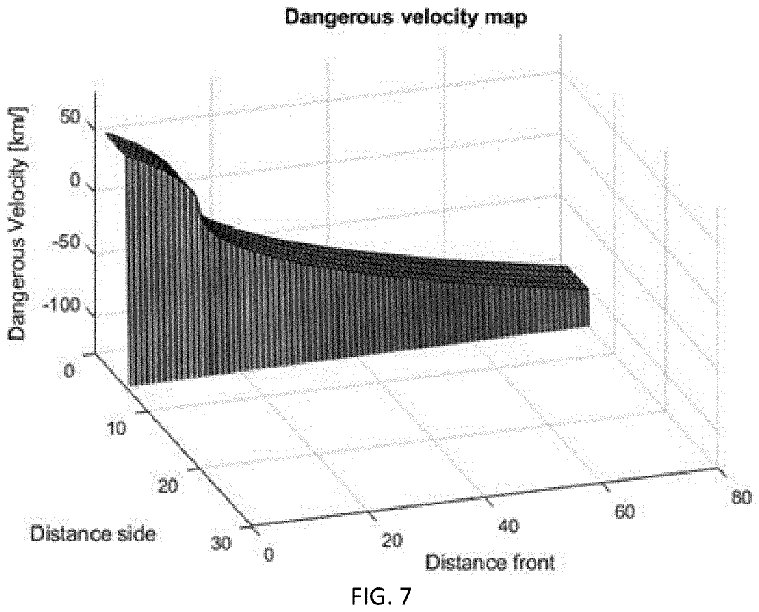

The shape of the dangerous or unsafe velocity distribution for a unified or finalized threat map may be non-uniform due to the combination of longitudinal (same and opposite direction) and lateral movements. For example, FIG. 7 shows a dangerous velocity map showing the dangerous or unsafe velocities at difference distances, e.g., front (longitudinal) and side (lateral).

In other cases, a threat map may be generated in which other parameters instead or in addition to dangerous velocities may be considered and specified in the map segment or cells. Further, a threat map may show dangerous or unsafe velocities for by considering parameters in addition to or instead of merely lateral and/or longitudinal distances between an ego vehicle and an object using a safety driving model.

According to some aspects of the present disclosure, the threat map may consider a plurality of traffic situations. For example, instead of considering a single traffic situation being used, a plurality of traffic situations may be evaluated to determine or calculate an unsafe velocity.

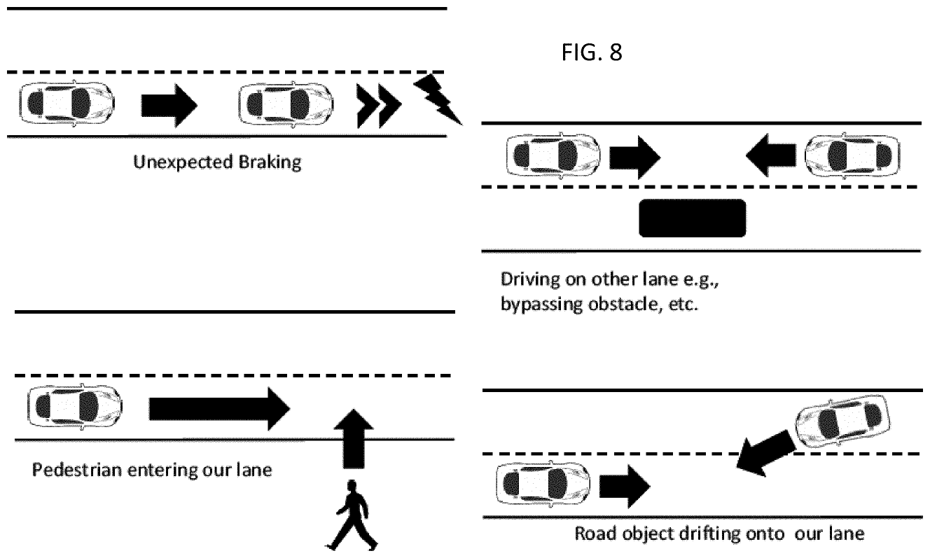

FIG. 8 shows a representation of a plurality of different exemplary traffic situations that may be used in accordance with aspects of the present disclosure. The traffic situations include 1) an unexpected braking from a road user (e.g., vehicle) in front on the ego vehicle, 2) a vulnerable road user (e.g., a pedestrian) with a certain heading and velocity entering on a road lane on which the ego vehicle is traveling, 3) an ego vehicle bypassing a first road user (e.g., vehicle) with an oncoming road user (e.g., second vehicle), and 4) an road user (e.g., oncoming vehicle) entering into the ego vehicle's lane. Other traffic situations including other types of road objects may also be considered. From the consideration of multiple traffic situations, a minimum unsafe velocity may be chosen to represent a cell in a threat map layer according to aspects of the present disclosure.

While threat maps may have the core information based on velocities, an improvement can be realized by considering and applying the uncertainties of physical parameters, such as velocity and position.

In at least one example, a threat map may be generated with a probabilistic collision risk included for each of its segments or cells. This type of map may be used or accessed during run-time to check a perceived object with a perceived position with an estimate of perception error.

Accordingly, referring back to FIG. 3, the process 300 may be used to generate a threat map that incorporates uncertainties. For example, in the most common sensor and perception systems, a perceived object is usually not represented by a fixed bounding box, and a single velocity value. Instead, relevant parameters such as size, classification, velocity and acceleration can be represented by probabilistic parametric distributions because of the inherent physical properties of the sensing systems and the uncertainties of many applications, e.g., AI algorithms.

Accordingly, the process 300 for creating a threat map using uncertainities is similar to the process for generating a threat map with unsafe velocities. For example, at 330, at least one road actor or object may be generated or defined for the selected segment or subsection so as to be modeled to move with an expected velocity v₀ under a given co-variance σᵥ instead of simply moving or traveling with a velocity v. Further, the road object may also be defined similarly with uncertainty for other parameters such as position. Threat maps described herein can be created or generated to incorporate or use such uncertainties.

For example, the expected velocity and/or position for the road object(s) may be used or applied to the safety driving model at 340. However, instead of creating a threat map with unsafe velocity values, a risk given a distribution (e.g., velocity distribution and a position distribution) can be calculated based using the output of the safety driving model.

In the present disclosure, risk may be considered as the probability of something happening multiplied by the resulting cost or benefit. According to at least one aspect of the present disclosure, risk can be calculated as:

Risk Rₑ=Combination of risk event probability Pₑ with severity Cₑ, if the event e

happens.

In aspects of the present disclosure, the event is a collision, with P_{c} representing the collision probability, and Cₑ representing the collision severity.

Collision risk values may be determined using the following uncertainty-aware collision risk model:

Rₑ(t,Δt)=σ⁻¹*Iₑ(t)*Cₑ(t) (2)

where τ⁻¹*Iₑ(t) represents the collision probability Pₑ, with τ⁻¹ being a model constant describing the influence of the collision probability on the overall risk and the function Iₑa so-called collision indicator function Iₑ which represents the likelihood of a collision using Gaussian Error functions (erf):

$${I}_{e} = \frac{1}{2} [ erf \{ \frac{{d}_{0} - d ( t )}{√ 2 σ ( t )} \} + 1 ] \qquad ( 3 )$$

In short, risk R may be indicated as being proportional to Iₑ*Cₑ. Indicator functions, such as the indicator function Iₑ above in equation (3) can depend on the distance (d) and distance uncertainty (a) of the object at time point t. Therefore, the indicator function can depend on the velocity and acceleration uncertainties of the objects. The parameter d₀ is a constant reflecting the minimum distance, below which a collision event is inevitable. Using such an approach, it is possible to estimate an uncertainty-aware collision risk for an ego vehicle-object pair.

In some examples, the distance (d) can be calculated using the safety driving model at the 335, which is then applied to the a risk model at 340. In equation (3) d(t) is the predicted distance at time t, given the current distance. Any prediction technique (e.g. constant velocity, constant acceleration) is possible and may be used. For example, it is also possible to use the safety metric of safety driving model (e.g., the front car does a brake with parameter bₘₐₓ, and the rear car reacts after rho seconds before braking with parameter bₘᵢₙ), to predict d(t).

While the above-equations can represent one type of risk model, other suitable risk models that using other equations and parameters may be used.

As shown in FIG. 3, risk values determined by applying uncertainty can be stored at 345. The process for generating risk values, like unsafe velocities, may be done in a segmented manner, where respective map cells or subsections are assigned risk values.

Further the generation of a risk value for a subsection may also be done considering a plurality of traffic situations. Further, the process may also be done on in a multi-layer manner, where each map layer generated with the ego vehicle having a certain parameter value(s) (e.g., velocity).

In some cases, risk values for some map cells may be determined from neighboring cells or segments. In other words, the risk values for subsections at 350 may be calculated or determined from the risk values already calculated from neighboring subsection(s) or cell(s). That is, to increase the efficiency, a neighboring or adjacent segment might only contain the delta to the threat map values of the previous segment or a geometrical transformation (e.g. translation or rotation). Since a threat map should be similar for straight roads, for most of the segments the delta between two consecutive lane segments will be just zero.

Further, as described with respect to the unsafe velocity threat map, the risk values may be done for a plurality of variations. That is, a plurality of threat map layer may be generated with each one having collision risk values with respect to a particular parameter (e.g., ego vehicle velocity) being constant for the threat map layer. Again, after all desired threat map layers have been created, a single unified threat map may be created by including collision risk values in each respective subsection or segment. The threat map may have, for each subsection, segment, or cell, a maximum acceptable collision risk value determined from the collision risk values contained in the corresponding subsections of the plurality of map layers. Accordingly, the final generated threat map can specify a maximum collision risk values for each subsection or cell.

With regard to FIG. 3, yet another approach may be implemented. The steps from 310 to 325 may be similar except, that at 330, the road actor or road object may be modeled or defined using a distribution of parameters such as position and velocity. At 335 and 340, a safety driving model and risk model can be used to determine which parameter values (velocity, position, etc.) corresponding to sensing distributions will lead to a safe situation or would lead to the most defensive driving style or the values with the highest risk. The value(s) leading to the highest risk along with an uncertainty range can be stored in each map segment. That is, the determination of parameters of the road actor or object with highest risk can be done on a segment-by-segment basis for some or all of the map subsections or segments. Accordingly, for such an approach, velocity and position distributions with the uncertainty (sigma) can be used to determine or find using risk models that have the highest risk.

Then when applying the threat map, an ego vehicle may assume the worst case when applying such a map. For example, if the ego vehicle or object estimates the velocity of another object is 30 km/h with uncertainty or sigma of 1 km/h (which may be values from a velocity distribution for the road object), the ego vehicle may assume a final velocity of 33 km/h which can then be compared against the correspond threat map cell. If the assumed velocity is within the range of the unsafe velocity, position, etc., then the ego vehicle can modify its driving behavior accordingly.

As in other examples, parameters for some subsections may be determined from the already determined parameters of neighboring cells or segments (see 350). The determined parameters may be stored at 345.

As before, the determination of parameters may also be done so to create a plurality of map layers, with each map layer corresponding to a particular parameter (e.g., velocity) of the ego vehicle. Finally, the map layers may be unified with each subsection or cell of the finalized threat map having segments indicating the parameters leading to the most defensive driving or highest risk from all the map layers generated. Each cell of the threat map layer can include values (e.g., velocity values with an uncertainty)

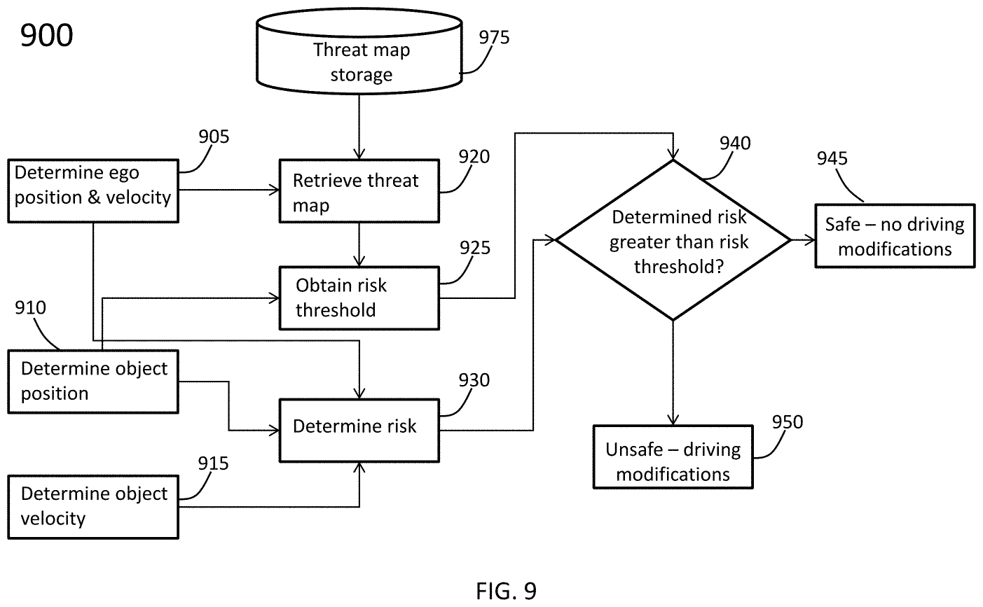

FIG. 9 shows an exemplary process for using a threat map including risk values. Further, such process could be adapted to for using other threat maps, including threat maps described herein, such as those including unsafe velocities and the like. This process may be implemented by an ego vehicle, e.g., an AV. For examples, the process 900 may be implemented by at least one processor implementing or executing instructions to perform the functions described in the process 900.

The process may include at 905, of obtaining the ego vehicle position and velocity. These parameters may be acquired using any suitable means including means described herein. Further, the process may include determining, at 910, road actor or road object position, and at 915, determining the road actor or object's velocity. Such parameters or values may also be determined through any suitable means, e.g., using a sensor system of the vehicle.

Using the determined ego vehicle position and velocity, a threat map at 920 may be obtained. For example, the threat map storage 975 may include one or plurality of threat maps corresponding to different geographical regions. Therefore, the threat map obtained or retrieved is one that is one relevant or corresponding to the determined position of the ego vehicle.

In one example, the threat map used may be one that was generated according to aspects described herein in which the segments respectively include data indicating a maximum acceptable collision risk values. Using the obtained threat map and using the determined position of the ego vehicle and the object position, a risk value or risk threshold can be obtained or retrieved from the threat map at 925. Further, using the determined ego vehicle parameters (position, velocity, etc.) and the determined or sensed object parameters (position, velocity) a risk may be calculated at 930. The obtained risk threshold and the determined risk can be compared at 940.

If the determined risk is less than or equal to the risk threshold, than at 945 the ego vehicle is considered safe and not requiring any changes or modification to its current driving approach and driving parameters. However, if the determined risk is greater than the risk threshold, than at 950, the driving approach and driving parameters are required to be modified so as to reduce the risk of the ego vehicle. In cases, the driving parameters selected or updated to alter driving behavior may include ones including a braking action (e.g., lateral and/or longitudinal breaking of ego vehicle), steering actions (e.g., steering, turning, etc.), etc.

This process 900 may be repeatedly performed to keep the ego vehicle having an acceptable level of risk.

Further, the process may be modified for using other threat maps. That is, a threat map with unsafe velocities, as described herein may be used. The process would be similar except the unsafe velocity would be obtained and compared against the current velocity of the vehicle. If the velocity of the vehicle is below the unsafe velocity, no changes would be made to ego vehicle's driving behavior. If the velocity of the vehicle is equal to or greater than the unsafe velocity, then modifications to the driving behavior, e.g., driving model parameters can be instituted or implemented.

In another example, other threat maps may be used for a process similar to process 900. For example, the threat map used may be one that includes velocity and/or position values with uncertainty margins. The information stored in cells or subsections of such a threat map cells may include velocity values with an uncertainty measurement which can be used to determine whether the ego vehicle needs to modify its driving behavior by comparing a worst case detected velocity and position (e.g., detected velocity and position with uncertainty values added) to the values obtained from the threat map. If the worst case detected values are greater than or equal to the range of the velocity and position values obtained from the threat map, then the driving behavior of vehicle is modified or altered (new driving parameters are implemented) to increase the safety of the vehicle.

That is, in according to aspects of the present disclosure, the use of a risk-aware spatial threat map can allow an ego vehicle (e.g., an AV) to evaluate (online or real-time) the safety of the current state of the system with respect to each surrounding road user more efficiently and accurately, allowing the vehicle to take preventive actions when safety being jeopardized.

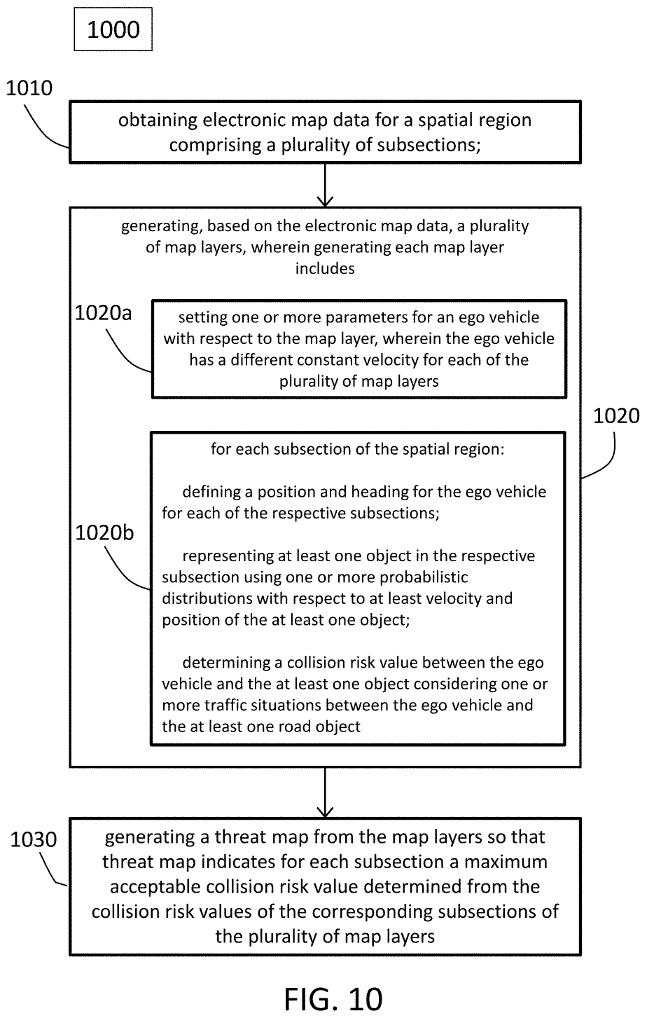

FIG. 10 shows an exemplary process for generating a threat map according to aspects of the present disclosure. The process may be done by one or more processors implementing or executing instructions. At 1010, the process includes, obtaining electronic map data for a spatial region comprising a plurality of subsections. In some cases, an unsegmented electronic map may be obtained which is then subsequently processed so as to be segmented.

After, obtaining the electronic map data, the process can include at 1020, generating a plurality of threat map layers at 1020. The generation of threat map layers at 1020 can include, at 1020a, setting one or more parameters for an ego vehicle with respect to the map layer, wherein the ego vehicle has a different constant velocity for each of the plurality of map layers being generated.

Further, the generation of threat map layers includes at 1020b, for each subsection of the spatial region of the electronic map, defining a position and heading for the ego vehicle for each of the respective subsections, representing at least one object in the respective subsection using one or more probabilistic distributions with respect to at least velocity and position of the at least one object, and determining a collision risk value between the ego vehicle and the at least one object considering one or more traffic situations between the ego vehicle and the at least one road object.

After generating the map layer, the process includes at 1030, generating a threat map from the map layers so that threat map indicates for each subsection a maximum acceptable collision risk value determined from the collision risk values of the corresponding subsections of the plurality of map layers.

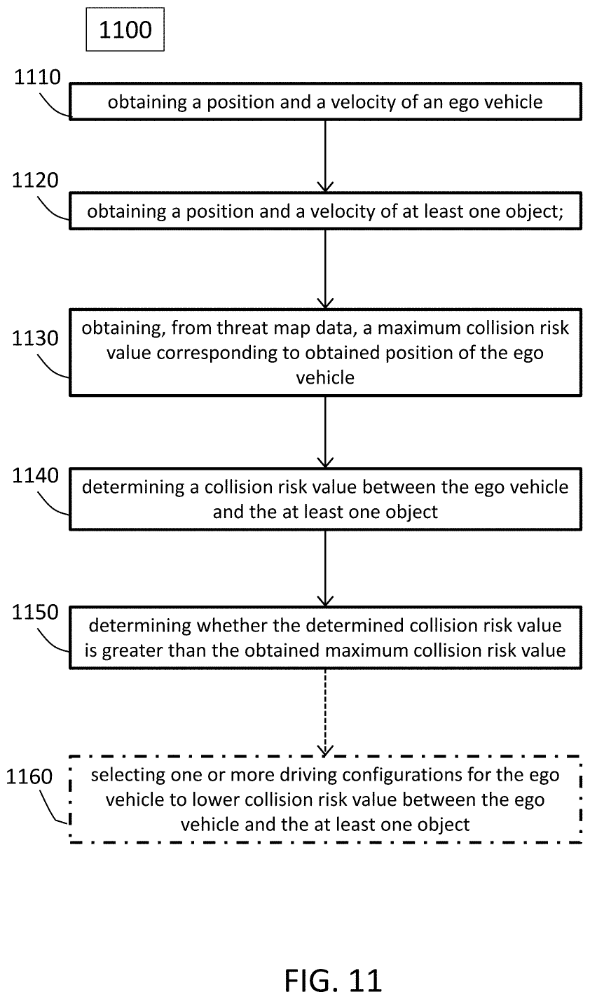

FIG. 11 shows an exemplary process 1100 for using a threat map according to aspects of the present disclosure. The method may be used or performed by a road user e.g., an ego vehicle. The method 1100 includes at 1110, obtaining a position and a velocity of an ego vehicle. At 1120, the method includes obtaining a position and a velocity of at least one object. The road object may be one that is detected by (e.g., by sensors) the ego vehicle. The method includes at 1130, obtaining, from threat map data, a maximum collision risk value corresponding to obtained position of the ego vehicle. The threat map may be a threat map described herein, which includes a spatiotemporal representation of the ego vehicle. At 1140, the method includes determining a collision risk value between the ego vehicle and the at least one object. Next at 1150, the method includes determining whether the determined collision risk value is greater than the obtained maximum collision risk value. In cases where the determined collision risk value is greater than the obtained maximum collision risk value, then the meth may include at 1160, selecting one or more driving configurations for the ego vehicle to lower collision risk value between the ego vehicle and the at least one object. These driving configurations may cause an update or change to driving model parameters for the ego vehicle. The ego vehicle, based on the updated or changed driving model parameters may implement any suitable and appropriate type of action(s) to reduce collision risk. These actions may include any type of braking actions (e.g., lateral and/or longitudinal), steering actions, evasive maneuvers, etc. The action(s) may include a combination of such actions. For example, a lateral evasive maneuver may be selected which can involve braking laterally and stabilizing the vehicle in a target lane (e.g., a lane-change).

In aspects of the present disclosure, the threat maps generated herein may be realized in any suitable type or form of coordinate system. The map can be realized in multiple formats including rectangular grids, polar grids, etc. The grids of a threat map have uniform or non-uniform cell or segment resolution. A threat map may generated be defined either in Cartesian space or in other spaces known in the art such as Special Lane Coordinate system (LCS). Further, it may be possible to combine usage of different map formats. For example, it may be possible to combine usage of a Cartesian and an LCS map.

Threat maps described herein may be or use car coordinates in which the origin of the map is at the position of the ego vehicle (e.g. rear axle of the vehicle). Further, the threat maps generated herein may only be generated certain subareas of geographical areas. That is, one threat map may be implemented to cover non-intersection scenarios. Further, for intersections a special threat map might be generated and used for different types of connections between the lanes.

In one example, when the road is sufficiently straight (e.g. freeways) a Cartesian threat map may be used. At intersections or bending roads an LCS based threat may be used.

In aspects of the present disclosure, the threat map generation may be done offline. After the threat map has been generated, it may be transferred or uploaded to a suitable destination e.g., a vehicle. Hence, in some cases, the threat map information can be stored together with a driving map. Further, a threat map or its information may be added to a lane segment or section of a lane segment in the driving map.

The threat maps which are produced off-line are beneficial because performing online safety checks based on instantaneous measurements of the dynamics of all objects around the ego vehicle is computationally intensive and to some extent contextually repeatable. Due to the deterministic nature of some of these safety approaches, the vehicle (e.g., AV) can optimize its resources by storing in memory the results of deterministic calculations to i) help optimize energy consumption ii) dedicate processing power to other demanding tasks and iii) reduce safety computation latency. Additionally, in normal driving situations, the same calculations are done repeatedly. For example, in stopped traffic due to a red traffic light, the dynamics of the objects around the ego vehicle remain the same for several seconds (sometimes even minutes), therefore, doing the online safety checks at a normal rate is a waste of resources.

In addition, this information has to be available early in the processing chain, and not as late, as only this allows special treatment of safety-critical objects in perception (e.g. to reduce uncertainties), prediction or trajectory planning (e.g. increased safety margins).

Hence, the methods and systems herein provide means for reducing computations during runtime via a priori preoccupations and knowledge resources (offline) is of great benefit. The methods and systems allow vehicle processing chains to understand, as early as possible, which objects and regions surrounding the vehicle can impact the safety, so computational resources can be focused on these regions. This extends the abilities of existing driving safety models, which only addresses the decision-making aspects of the processing chain.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The phrases “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The phrases “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group including the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit, and may also be referred to as a “processing circuit,” “processing circuitry,” among others. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality, among others, and conversely that any single processor, controller, or logic circuit detailed herein may be realized as two (or more) separate entities with equivalent functionality, among others.

As used herein, “memory” is understood as a computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “vehicle” may be understood to include any type of driven or drivable object. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, and the like.

A “ground vehicle” may be understood to include any type of vehicle, as described above, which is configured to traverse or be driven on the ground, e.g., on a street, on a road, on a track, on one or more rails, off-road, etc. An “aerial vehicle” may be understood to be any type of vehicle, as described above, which is capable of being maneuvered above the ground for any duration of time, e.g., a drone. Similar to a ground vehicle having wheels, belts, etc., for providing mobility on terrain, an “aerial vehicle” may have one or more propellers, wings, fans, among others, for providing the ability to maneuver in the air. An “aquatic vehicle” may be understood to be any type of vehicle, as described above, which is capable of being maneuvers on or below the surface of liquid, e.g., a boat on the surface of water or a submarine below the surface. It is appreciated that some vehicles may be configured to operate as one of more of a ground, an aerial, and/or an aquatic vehicle.

The term “autonomous vehicle” may describe a vehicle capable of implementing at least one navigational change without driver input. A navigational change may describe or include a change in one or more of steering, braking, or acceleration/deceleration of the vehicle. A vehicle may be described as autonomous even in case the vehicle is not fully automatic (e.g., fully operational with driver or without driver input). Autonomous vehicles may include those vehicles that can operate under driver control during certain time periods and without driver control during other time periods. Autonomous vehicles may also include vehicles that control only some aspects of vehicle navigation, such as steering (e.g., to maintain a vehicle course between vehicle lane constraints) or some steering operations under certain circumstances (but not under all circumstances), but may leave other aspects of vehicle navigation to the driver (e.g., braking or braking under certain circumstances). Autonomous vehicles may also include vehicles that share the control of one or more aspects of vehicle navigation under certain circumstances (e.g., hands-on, such as responsive to a driver input) and vehicles that control one or more aspects of vehicle navigation under certain circumstances (e.g., hands-off, such as independent of driver input). Autonomous vehicles may also include vehicles that control one or more aspects of vehicle navigation under certain circumstances, such as under certain environmental conditions (e.g., spatial areas, roadway conditions). In some aspects, autonomous vehicles may handle some or all aspects of braking, speed control, velocity control, and/or steering of the vehicle. An autonomous vehicle may include those vehicles that can operate without a driver. The level of autonomy of a vehicle may be described or determined by the Society of Automotive Engineers (SAE) level of the vehicle (e.g., as defined by the SAE, for example in SAE J3016 2018: Taxonomy and definitions for terms related to driving automation systems for on road motor vehicles) or by other relevant professional organizations. The SAE level may have a value ranging from a minimum level, e.g. level 0 (illustratively, substantially no driving automation), to a maximum level, e.g. level 5 (illustratively, full driving automation).

In the context of the present disclosure, “vehicle operation data” may be understood to describe any type of feature related to the operation of a vehicle. By way of example, “vehicle operation data” may describe the status of the vehicle such as the type of propulsion unit(s), types of tires or propellers of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, etc. More generally, “vehicle operation data” may describe or include varying features or varying vehicle operation data (illustratively, time-varying features or data).

Various aspects herein may utilize one or more machine learning models to perform or control functions of the vehicle (or other functions described herein). The term “model” as, for example, used herein may be understood as any kind of algorithm, which provides output data from input data (e.g., any kind of algorithm generating or calculating output data from input data). A machine learning model may be executed by a computing system to progressively improve performance of a specific task. In some aspects, parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be adjusted during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, any of the machine learning models may utilize supervised learning, semi-supervised learning, unsupervised learning, or reinforcement learning techniques.

In supervised learning, the model may be built using a training set of data including both the inputs and the corresponding desired outputs (illustratively, each input may be associated with a desired or expected output for that input). Each training instance may include one or more inputs and a desired output. Training may include iterating through training instances and using an objective function to teach the model to predict the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training set of data including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

Various aspects described herein may utilize one or more classification models. In a classification model, the outputs may be restricted to a limited set of values (e.g., one or more classes). The classification model may output a class for an input set of one or more input values. An input set may include sensor data, such as image data, radar data, LIDAR data and the like. A classification model as described herein may, for example, classify certain driving conditions and/or environmental conditions, such as weather conditions, road conditions, and the like. References herein to classification models may contemplate a model that implements, e.g., any one or more of the following techniques: linear classifiers (e.g., logistic regression or naive Bayes classifier), support vector machines, decision trees, boosted trees, random forest, neural networks, or nearest neighbor.

Various aspects described herein may utilize one or more regression models. A regression model may output a numerical value from a continuous range based on an input set of one or more values (illustratively, starting from or using an input set of one or more values). References herein to regression models may contemplate a model that implements, e.g., any one or more of the following techniques (or other suitable techniques): linear regression, decision trees, random forest, or neural networks.

A machine learning model described herein may be or may include a neural network. The neural network may be any kind of neural network, such as a convolutional neural network, an autoencoder network, a variational autoencoder network, a sparse autoencoder network, a recurrent neural network, a deconvolutional network, a generative adversarial network, a forward-thinking neural network, a sum-product neural network, and the like. The neural network may include any number of layers. The training of the neural network (e.g., adapting the layers of the neural network) may use or may be based on any kind of training principle, such as backpropagation (e.g., using the backpropagation algorithm).

Throughout the present disclosure, the following terms may be used as synonyms: driving parameter set, driving model parameter set, safety layer parameter set, driver assistance, automated driving model parameter set, and/or the like (e.g., driving safety parameter set). These terms may correspond to groups of values used to implement one or more models for directing a vehicle to operate according to the manners described herein.

Furthermore, throughout the present disclosure, the following terms may be used as synonyms: driving parameter, driving model parameter, safety layer parameter, driver assistance and/or automated driving model parameter, and/or the like (e.g., driving safety parameter), and may correspond to specific values within the previously described sets.

In the following, various aspects of the present disclosure will be illustrated:

Example 1 is a computer-implemented method for creating a road user spatio-temporal representation, the method may include: obtaining electronic map data for a spatial region comprising a plurality of subsections; generating, based on the electronic map data, a plurality of map layers, wherein generating each map layer includes: setting one or more parameters for an ego vehicle with respect to the map layer, wherein the ego vehicle has a different constant velocity for each of the plurality of map layers; wherein for each subsection of the spatial region, the method further includes—defining a position and heading for the ego vehicle for each of the respective subsections; —representing at least one object in the respective subsection using one or more probabilistic distributions with respect to at least velocity and position of the at least one object; and—determining a collision risk value between the ego vehicle and the at least one object considering one or more traffic situations between the ego vehicle and the at least one road object; and the method further including generating a road user spatio-temporal representation from the map layers that indicates for each subsection thereof a maximum acceptable collision risk value determined from the collision risk values of the corresponding subsections of the plurality of map layers.

Example 2 is the subject matter of Example 1, wherein determining each collision risk value can optionally include applying a safety driving model for each of the one or more traffic situations considered.

Example 3 is the subject matter of Example 2. The method of claim 1, wherein determining the collision risk values can optionally include applying a collision risk model.

Example 4 is the subject matter of any of Examples 1 to 3, wherein the at least one object may include a second road user.

Example 5 is the subject matter of Example 4, wherein the one or more traffic situations may include a situation in which the ego vehicle following the second road user.

Example 6 is the subject matter of Example 4 or 5, wherein the one or more traffic situations may include a situation in which the ego vehicle approaching the second road user which is traveling in a direction opposite to the ego vehicle.

Example 7 is the subject matter of Example 5, wherein the at least one object further may include a third road user and wherein the one or more traffic situations may include a situation in which the ego vehicle is overtaking the second road user traveling in the same direction as the ego vehicle and the third is approaching the ego vehicle in a direction opposite to the ego vehicle.

Example 8 is the subject matter of any of Examples 1 to 7, wherein the at least one object comprises a vulnerable road user, and wherein the one or more traffic situations comprise a situation in which the vulnerable road user entering a lane through which the ego vehicle is traveling.

Example 9 is the subject matter of any of Examples 1 to 8, wherein one or more of the plurality of subsections corresponds respectively to one or more road segments.

Example 10 is the subject matter of any of Examples 1 to 9, wherein the plurality of subsections comprises a polar grid.

Example 11 is the subject matter of any of Examples 1 to 9, wherein the plurality of subsections comprises a rectangular grid.

Example 12 is a method for determining safety of a vehicle including: obtaining a position and a velocity of an ego vehicle; obtaining a position and a velocity of at least one object; obtaining a maximum collision risk value corresponding to obtained position of the ego vehicle; determining a collision risk value between the ego vehicle and the at least one object; and determining whether the determined collision risk value is greater than the obtained maximum collision risk value.

Example 13 is the subject matter of Example 12, wherein obtaining the maximum collision risk value optionally includes: obtaining maximum collision risk value from a road user spatio-temporal representation comprising a plurality of subsections corresponding to a spatial region, wherein the road user spatio-temporal representation indicates for each subsection a single maximum acceptable collision risk value, wherein the obtained maximum collision risk value is the single maximum acceptable collision risk value of the subsection corresponding to the determined position of the ego vehicle.

Example 14 is the subject matter of Example 12 or 13, wherein determining a collision risk value between the ego vehicle and the at least one object optionally includes using a driving safety model to determine the collision risk value between the ego vehicle and the at least one object.

Example 15 is the subject matter of any of Examples 12 to 14, wherein determining whether the determined collision risk value is greater than the obtained maximum collision risk value optionally includes determining that the determined collision risk value is greater than the maximum collision risk value, and selecting one or more driving configurations for the ego vehicle to lower collision risk value between the ego vehicle and the at least one object.

Example 16 is the subject matter of Example 15, wherein the one or more selected driving configurations may include a driving countermeasure.

Example 17 is the subject matter of Example 16, wherein the countermeasure may include a braking action.

Example 18 is the subject matter of Example 16, wherein the countermeasure may include an evasive maneuver.

Example 19 is the subject matter of Example 16, wherein the countermeasure may include a steering action.

Example 20 is the subject matter of any of Examples 12 to 19, wherein determining whether the determined collision risk value is greater than the obtained maximum collision risk value may include determining that the determined collision risk value is less than or equal to the maximum collision risk value, and maintaining a current driving configurations for the ego vehicle.

Example 21 is a computer-implemented method for creating a road user spatio-temporal representation, the method including: obtaining electronic map data for a spatial region comprising a plurality of subsections; defining at least one object with respect to the spatial region; generating, based on the electronic map data, a plurality of map layers, wherein generating each map layer comprises: setting a travel velocity for an ego vehicle with respect to the map layer, wherein the ego vehicle has a different travel velocity for each of the plurality of map layers; wherein for each subsection of the spatial region, the method further comprises defining a position and heading for the ego vehicle for each of the respective subsections; determining one or more safety parameters for the at least one object that would impose a safety threat to the ego vehicle traveling at the set velocity at the defined position and heading by considering one or more traffic situations between the ego vehicle and the at least one road object using the probabilistic distributions for the at least one object; and the method further includes generating a road user spatio-temporal representation for the spatial region wherein the road user spatio-temporal representation comprises data for each subsection of the spatial region including minimum safety parameters from the safety traffic parameters from the corresponding subsections of the plurality of map layers.

Example 22 is the subject matter of Example 21, wherein determining the one or more safety parameters of the at least one object optionally includes determining the one or more parameters of the at least one object that would impose a safety threat to the ego vehicle comprises according to a safety driving model for each of the one or more traffic situations considered.

Example 23 is the subject matter of Example 21 or 22, wherein the one or more safety parameters may include at least one velocity value of the at least one object.

Example 24 is the subject matter of Example 23, wherein the at least one velocity value comprises a longitudinal and/or a lateral velocity value.

Example 25 is the subject matter of any of Examples 21 to 24, wherein the safety parameters may include a distance value between the ego vehicle and the at least one object.

Example 26 is a non-transitory computer-readable medium containing instructions that when performed by at least one processor, cause the processor to perform a method in any of the Examples above (i.e., Examples 1-25).

Example 27 is an apparatus for creating a road user spatio-temporal representation, the apparatus including: means for obtaining electronic map data for a spatial region comprising a plurality of subsections; means for generating, based on the electronic map data, a plurality of map layers, wherein the means for generating each map layer includes: means for setting one or more parameters for an ego vehicle with respect to the map layer, wherein the ego vehicle has a different constant velocity for each of the plurality of map layers; wherein for each subsection of the spatial region, the means for generating each map layer further comprises means for defining a position and heading for the ego vehicle for each of the respective subsections; means for representing at least one object in the respective subsection using one or more probabilistic distributions with respect to at least velocity and position of the at least one object; and means determining a collision risk value between the ego vehicle and the at least one object considering one or more traffic situations between the ego vehicle and the at least one road object; and wherein the apparatus further includes means for generating a road user spatio-temporal representation from the map layers that indicates for each subsection thereof a maximum acceptable collision risk value determined from the collision risk values of the corresponding subsections of the plurality of map layers.

Example 28 is an apparatus for creating a road user spatio-temporal representation, the apparatus including: means for obtaining electronic map data for a spatial region comprising a plurality of subsections; means for generating, based on the electronic map data, a plurality of map layers, wherein the means for generating each map layer include: means for setting one or more parameters for an ego vehicle with respect to the map layer, wherein the ego vehicle has a different constant velocity for each of the plurality of map layers; and wherein for each subsection of the spatial region, the means for generating each map layer further includes means for defining a position and heading for the ego vehicle for each of the respective subsections; means for representing at least one object in the respective subsection using one or more probabilistic distributions with respect to at least velocity and position of the at least one object; and means for determining for a velocity value and position value associated with a highest collision risk value between the ego vehicle and the at least one object considering one or more traffic situations between the ego vehicle and the at least one road object; wherein the apparatus further includes means for generating a road user spatio-temporal representation from the map layers that indicates for each subsection thereof the velocity value and position value associate with a maximum collision risk value from the velocity values and position values of the corresponding subsections and of the plurality of map layers and further indicates an uncertainty margin for at least the velocity value.

Example 29 is an apparatus for determining safety of a vehicle, the apparatus including: means for obtaining a position and a velocity of an ego vehicle; means for obtaining a position and a velocity of at least one object; means for obtaining a maximum collision risk value corresponding to obtained position of the ego vehicle; means for determining a collision risk value between the ego vehicle and the at least one object; and means for determining whether the determined collision risk value is greater than the obtained maximum collision risk value.

Example 30 is an apparatus for creating a road user spatio-temporal representation, the apparatus including: means for obtaining electronic map data for a spatial region comprising a plurality of subsections; means for defining at least one object with respect to the spatial region; means for generating, based on the electronic map data, a plurality of map layers, wherein generating each map layer includes: means for setting a travel velocity for an ego vehicle with respect to the map layer, wherein the ego vehicle has a different travel velocity for each of the plurality of map layers; wherein for each subsection of the spatial region, the means for generating each map layer further includes means for defining a position and heading for the ego vehicle for each of the respective subsections; means for determining one or more safety parameters for the at least one object that would impose a safety threat to the ego vehicle traveling at the set velocity at the defined position and heading by considering one or more traffic situations between the ego vehicle and the at least one road object using the probabilistic distributions for the at least one object; and wherein the apparatus further includes means for generating a road user spatio-temporal representation for the spatial region wherein the road user spatio-temporal representation comprises data for each subsection of the spatial region including minimum safety parameters, the minimum safety parameters for each subsection of the spatial region selected from a minimum of the safety traffic parameters from the subsections of the plurality of map layers that correspond to the respective subsection of the spatial region.

Example 31 is a vehicle including: a control system configured to control the vehicle to operate in accordance with a driving model including predefined driving model parameters; a safety system, comprising one or more processors configured to: obtain a position and a velocity of an ego vehicle; obtain a position and a velocity of at least one object; obtain a maximum collision risk value corresponding to obtained position of the ego vehicle; determine a collision risk value between the ego vehicle and the at least one object; and wherein determining whether the determined collision risk value is greater than the obtained maximum collision risk value optionally includes determining that the determined collision risk value is greater than the maximum collision risk value, and selecting one or more driving configurations for the ego vehicle to lower collision risk value between the ego vehicle and the at least one object; and change or update one or more of the driving model parameters to one or more changed or updated driving model parameters to reduce collision risk using the selected one or more driving configurations; and provide the one or more changed or updated driving model parameters to the control system for controlling the vehicle to operate in accordance with the driving model including the one or more changed or updated driving model parameters.

While the above descriptions and connected figures may depict electronic device components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A computer-implemented method for creating a road user spatio-temporal representation, the method comprising:
obtaining electronic map data for a spatial region comprising a plurality of subsections;
generating, based on the electronic map data, a plurality of map layers, wherein generating each map layer comprises:
setting one or more parameters for an ego vehicle with respect to the map layer, wherein the ego vehicle has a different constant velocity for each of the plurality of map layers;
wherein for each subsection of the spatial region, the method further comprises
defining a position and heading for the ego vehicle for each of the respective subsections;
representing at least one object in the respective subsection using one or more probabilistic distributions with respect to at least velocity and position of the at least one object;
determining a collision risk value between the ego vehicle and the at least one object considering one or more traffic situations between the ego vehicle and the at least one road object;
the method further comprising generating a road user spatio-temporal representation from the map layers that indicates for each subsection of the road user spatio-temporal representation, a maximum acceptable collision risk value determined from the collision risk values of the corresponding subsections of the plurality of map layers.

2. The method of claim 1, wherein determining each collision risk value comprises applying a safety driving model for each of the one or more traffic situations considered.

3. The method of claim 1, wherein determining the collision risk values comprises applying a collision risk model.

4. The method of claim 1, wherein the at least one object comprises a second road user.

5. The method of claim 4, wherein the one or more traffic situations comprise a situation in which the ego vehicle following the second road user.

6. The method of claim 4, wherein the one or more traffic situations comprise a situation in which the ego vehicle approaches the second road user and travels in a direction opposite to the ego vehicle.

7. The method of claim 5, wherein the at least one object further comprises a third road user, wherein the one or more traffic situations comprise a situation in which the ego vehicle is overtaking the second road user traveling in the same direction as the ego vehicle and the third is approaching the ego vehicle in a direction opposite to the ego vehicle.

8. The method of claim 1, wherein the at least one object comprises a vulnerable road user, and wherein the one or more traffic situations comprise a situation in which the vulnerable road user enters a lane through which the ego vehicle is traveling.

9. The method of claim 1, wherein one or more of the plurality of subsections corresponds respectively to one or more road segments.

10. A computer-implemented method for creating a road user spatio-temporal representation, the method comprising:
obtaining electronic map data for a spatial region comprising a plurality of subsections;
defining at least one object with respect to the spatial region;
generating, based on the electronic map data, a plurality of map layers, wherein generating each map layer comprises:
setting a travel velocity for an ego vehicle with respect to the map layer, wherein the ego vehicle has a different travel velocity for each of the plurality of map layers;
wherein for each subsection of the spatial region, the method further comprises
defining a position and heading for the ego vehicle for each of the respective subsections;
determining one or more safety parameters for the at least one object that would impose a safety threat to the ego vehicle traveling at the set velocity at the defined position and heading by evaluating, with the probabilistic distributions for the at least one object, one or more traffic situations between the ego vehicle and the at least one road object; and
generating a road user spatio-temporal representation for the spatial region wherein the road user spatio-temporal representation comprises data for each subsection of the spatial region including minimum safety parameters, the safety parameters for each subsection of the spatial region selected from a minimum of the safety traffic parameters from the subsections of the plurality of map layers corresponding to the respective subsection of the spatial region.

11. The method of claim 10, wherein determining the one or more safety parameters of the at least one object comprises determining the one or more parameters of the at least one object that would impose a safety threat to the ego vehicle comprises according to a safety driving model for each of the one or more traffic situations considered.

12. The method of claim 1, wherein the one or more safety parameters comprise at least one velocity value of the at least one object.

13. The method of claim 12, wherein the at least one velocity value comprises a longitudinal and/or a lateral velocity value.

14. The method of claim 10, wherein the safety parameters comprise a distance value between the ego vehicle and the at least one object.

15. A method for determining safety of a vehicle comprising:
obtaining a position and a velocity of an ego vehicle;
obtaining a position and a velocity of at least one object;
obtaining a maximum collision risk value corresponding to obtained position of the ego vehicle;
determining a collision risk value between the ego vehicle and the at least one object; and
determining whether the determined collision risk value is greater than the obtained maximum collision risk value.

16. The method of claim 15, wherein obtaining the maximum collision risk value comprises:
obtaining maximum collision risk value from a road user spatio-temporal representation comprising a plurality of subsections corresponding to a spatial region,
wherein the road user spatio-temporal representation indicates for each subsection a single maximum acceptable collision risk value, wherein the obtained maximum collision risk value is the single maximum acceptable collision risk value of the subsection corresponding to the determined position of the ego vehicle.

17. The method of claim 15, wherein determining a collision risk value between the ego vehicle and the at least one object comprises using a driving safety model to determine the collision risk value between the ego vehicle and the at least one object.

18. The method of claim 15, wherein determining whether the determined collision risk value is greater than the obtained maximum collision risk value comprises
determining that the determined collision risk value is greater than the maximum collision risk value, and
selecting one or more driving configurations for the ego vehicle to lower collision risk value between the ego vehicle and the at least one object.

19. The method of claim 18, wherein the one or more selected driving configurations comprise a driving countermeasure.

20. The method of claim 19, wherein the countermeasure comprises a braking action.

21. The method of claim 19, wherein the countermeasure comprises an evasive maneuver.

22. The method of claim 15, wherein determining whether the determined collision risk value is greater than the obtained maximum collision risk value comprises
determining that the determined collision risk value is less than or equal to the maximum collision risk value, and
maintaining a current driving configurations for the ego vehicle.

23. A non-transitory computer-readable medium containing instructions that when executed by at least one processor cause the processor to:
obtain electronic map data for a spatial region comprising a plurality of subsections;
generate, based on the electronic map data, a plurality of map layers, wherein to generate each map layer comprises:
to set one or more parameters for an ego vehicle with respect to the map layer, wherein the ego vehicle has a different constant velocity for each of the plurality of map layers;
wherein for each subsection of the spatial region, the at least one processor is to:
define a position and heading for the ego vehicle for each of the respective subsections;
represent at least one object in the respective subsection using one or more probabilistic distributions with respect to at least velocity and position of the at least one object;
determine a collision risk value between the ego vehicle and the at least one object considering one or more traffic situations between the ego vehicle and the at least one road object; and
the at least one processor further configured to generate a road user spatio-temporal representation from the map layers that indicates for each subsection of the road user spatio-temporal representation, a maximum acceptable collision risk value determined from the collision risk values of the corresponding subsections of the plurality of map layers.

24. A non-transitory computer-readable medium containing instructions that when executed by at least one processor cause the processor to:
obtain electronic map data for a spatial region comprising a plurality of subsections;
generate, based on the electronic map data, a plurality of map layers, wherein to generate each map layer comprises:
to set one or more parameters for an ego vehicle with respect to the map layer, wherein the ego vehicle has a different constant velocity for each of the plurality of map layers;
wherein for each subsection of the spatial region, the at least one processor is to:
define a position and heading for the ego vehicle for each of the respective subsections;
represent at least one object in the respective subsection using one or more probabilistic distributions with respect to at least velocity and position of the at least one object;
determine a collision risk value between the ego vehicle and the at least one object considering one or more traffic situations between the ego vehicle and the at least one road object; and
the at least one processor further configured to generate a road user spatio-temporal representation from the map layers that indicates for each subsection of the road user spatio-temporal representation, a maximum acceptable collision risk value determined from the collision risk values of the corresponding subsections of the plurality of map layers.

25. A vehicle comprising:
a control system configured to control the vehicle to operate in accordance with a driving model including predefined driving model parameters;
a safety system, comprising one or more processors configured to:
obtain a position and a velocity of an ego vehicle;
obtain a position and a velocity of at least one object;
obtain a maximum collision risk value corresponding to obtained position of the ego vehicle;
determine a collision risk value between the ego vehicle and the at least one object; and
wherein determining whether the determined collision risk value is greater than the obtained maximum collision risk value optionally includes determining that the determined collision risk value is greater than the maximum collision risk value, and selecting one or more driving configurations for the ego vehicle to lower collision risk value between the ego vehicle and the at least one object; and
change or update one or more of the driving model parameters to one or more changed or updated driving model parameters to reduce collision risk using the selected one or more driving configurations; and
provide the one or more changed or updated driving model parameters to the control system for controlling the vehicle to operate in accordance with the driving model including the one or more changed or updated driving model parameters.
